(19) United States
(12) Patent Application Publication
(10) Pub. No.: US 2010/0026207 A1
(43) Pub. Date: Feb. 4, 2010

(54) Current Regulation Unit In A Circuit Of Light Sources Connected In Series

(75) Inventors: Gianni Facchini, San Carlo (Ferrara) (IT); Giovanni Cannistra', Bologna (IT)

Correspondence Address: WILLIAM J. SAPONE;COLEMAN SUDOL SAPONE P.C., 714 COLORADO AVENUE, BRIDGE PORT, CT, 06605, US

(73) Assignee: O.C.E.M. S.P.A., S. Giorgio di Piano (Bologna) (IT)

(21) Appl. No.: 12/445,059

(22) PCT Filed: Oct. 9, 2007
(86) PCT No.: PCT/EP2007/060707

§ 371 Date: Apr. 9, 2009

(30) Foreign Application Priority Data
Oct. 11, 2006 (IT) BO2006U 000086

(51) Int. Cl. H05B 37/02

(52) U.S. Cl. 315/294

(57) ABSTRACT

A current regulation unit in a circuit composed of light sources, connected in series, interposed between an electric source (SE) and the series connection electric circuit (E) of the light sources (SI₁, SI₂, SI_{J}, SI_{N}), includes: at least one conversion apparatus (AC₁ AC₂) for generating an alternating voltage, having pre-settable characteristics; a transformer (T), connected in cascade to the conversion apparatus (AC₁, AC₂) and connected to the electric circuit (E); and an electric control unit (CE), connected to the conversion apparatus (AC₁, AC₂) for controlling the modulation of the alternating voltage supplied by the conversion apparatus, in order to obtain a current (z) circulating in the electric circuit (E) having pre-settable electric characteristics. The conversion apparatus (AC₁, AC₂) is mounted on a printed board (SC₁, SC₂), removable from a corresponding slot (SL₁, SL₂), made in the regulation unit (UR).

### FIELD OF THE INVENTION

The present invention lies in the technical field of constant current regulation units, aimed at feeding light sources connected in series, for example for serving the airport runways.

### DESCRIPTION OF THE PRIOR ART

Current regulation units are provided, even in large number, for feeding light sources connected in series, such as the runways lights in an airport (see FIG. 1, prior art) and each regulation unit is connected for example to a three-phase (or single-phase) power line SE to power an electric circuit E, in which a plurality of light sources SI₁, SI₂, . . . , SI_{J}, . . . , SI_{N} are connected in series; said regulation unit URN includes substantially: a conversion apparatus ACN composed, in turn, of an AC/DC rectifier, supplied by the three-phase (or single-phase) power line SE, that converts the alternating voltage in a direct voltage, and an inverter DC/AC, arranged in cascade with the rectifier AC/DC, and aimed at converting the direct voltage in an alternate voltage wave form, having pre-settable characteristics (frequency and/or amplitude and/or rms value; an electric transformer TN, having primary winding connected to the output of the same DC/AC inverter and the secondary winding connected to the electric circuit E; and an electric control unit C, that receives in input an external signal EXT, transmitted for example by the control tower, and a feedback control signal RET, supplied by a sensor S (such as a current transformer TA), representative of the current z circulating in the electric circuit E. The control unit is aimed at controlling the modulation of the voltage supplied by the DC/AC inverter by means of a corresponding signal KK.

Each light source SI_{J} includes a corresponding auxiliary device D_{J}, of known type, that supplies a relevant lamp L_{J}, for example a half-dipped signaling lamp (also known to those skilled in the field as “light signal”).

As specified, the electric control unit C has the task of controlling the modulation of the voltage created by the DC/AC inverter, for example in terms of variation of its rms value, depending on the result of the comparison between the external signal EXT and the feedback control signal RET: in particular, the external signal EXT contains information related to the light level required in the runway, therefore, in other words, the electric control unit C governs the control and regulation of the current z circulating in the electric circuit E, thus determining corresponding current values (not indicated) to supply the lamps L₁, L₂, . . . , L_{J}, . . . , L_{N}, the current being delivered by the auxiliary devices D₁, D₂, . . . , D_{J}, D_{N}.

The just described supply system must have high reliability standards, so as to ensure continuous and regular supply of the light sources SI₁, SI₂, . . . , SI_{J}, SI_{N}, for obvious security reasons. Consequently, some solutions (few, as a matter of fact) include a redundant regulation unit (not shown), arranged in parallel with the URN service unit and aimed at being set in operation, in case of failure or maintenance of the latter. Obviously, this solution protects the regular operation of this supply system, yet it causes a substantial increase of the overall costs and dimensions.

### SUMMARY OF THE INVENTION

In the light of what above, it is an object of the present invention to propose a unit for regulation of the current in a circuit composed of light sources connected in series, which is newly conceived and which resolves satisfactorily the just mentioned disadvantages of the prior art. It is intended to provide a unit that ensures high reliability standards and whose overall costs and dimensions are lower than the ones of the known solutions.

The above mentioned objects are obtained, in accordance with the contents of the claims, by a current regulation unit in a circuit composed of light sources, connected in series, the regulation unit being functionally interposed between an electric source and an electric circuit including the said light sources, connected in series, the regulation unit including:

at least one conversion apparatus, supplied by said electric source for generating an alternating voltage, having pre-settable characteristics;

an electric transformer, electrically connected in cascade to the same conversion apparatus and functionally connected to said electric circuit of said light sources; and

an electric control unit, connected to at least said conversion apparatus for controlling modulation of the alternating voltage supplied by said conversion apparatus so as to obtain a current in said electric circuit of said light sources having pre-settable electric characteristics, the current regulation unit being characterized in that said conversion apparatus is mounted on a board, removable from a corresponding slot, made in the same regulation unit.

### BRIEF DESCRIPTION OF THE DRAWINGS

The characteristic features of the invention, not appearing from what has been just said, will be better pointed out in the following description, in accordance with the contents of the claims and with help of the enclosed figures, in which:

FIG. 1 is an electric block diagram of the above described regulation unit of known type and of the electric circuit, supplied thereby, composed of a plurality of light sources, connected in series;

FIG. 2 is an electric block diagram of the regulation unit proposed by the present invention, as well as of the electric circuit, supplied thereby, composed of the above mentioned plurality of light sources, connected in series;

FIG. 3 is a front, schematic view of the regulation unit and of the electric circuit, supplied thereby.

### BEST MODES OF CARRYING OUT THE INVENTION

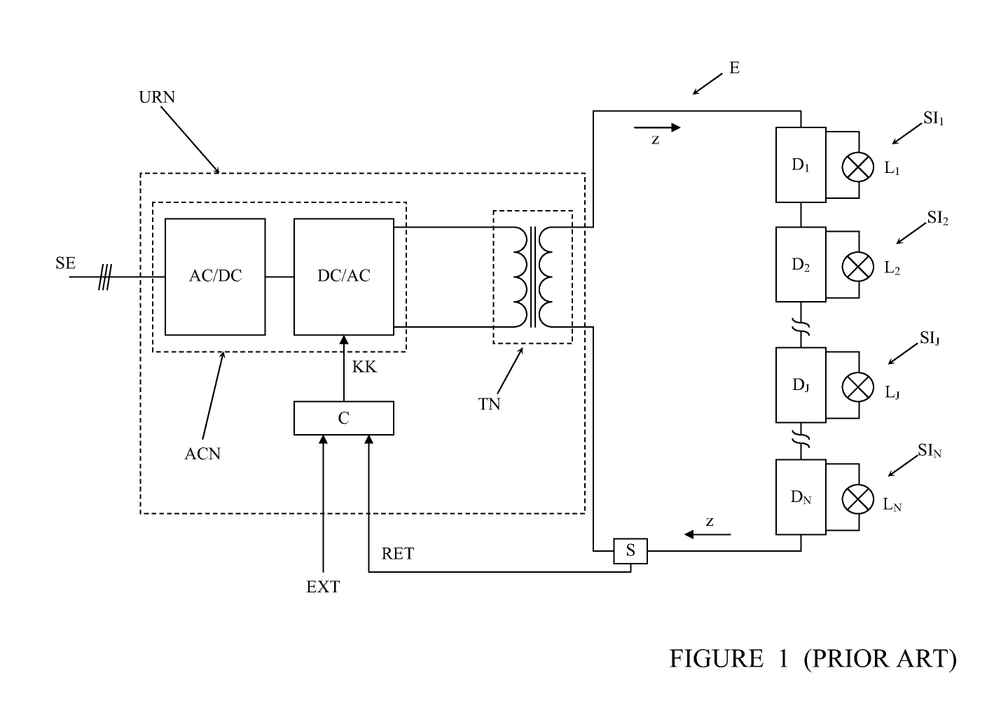

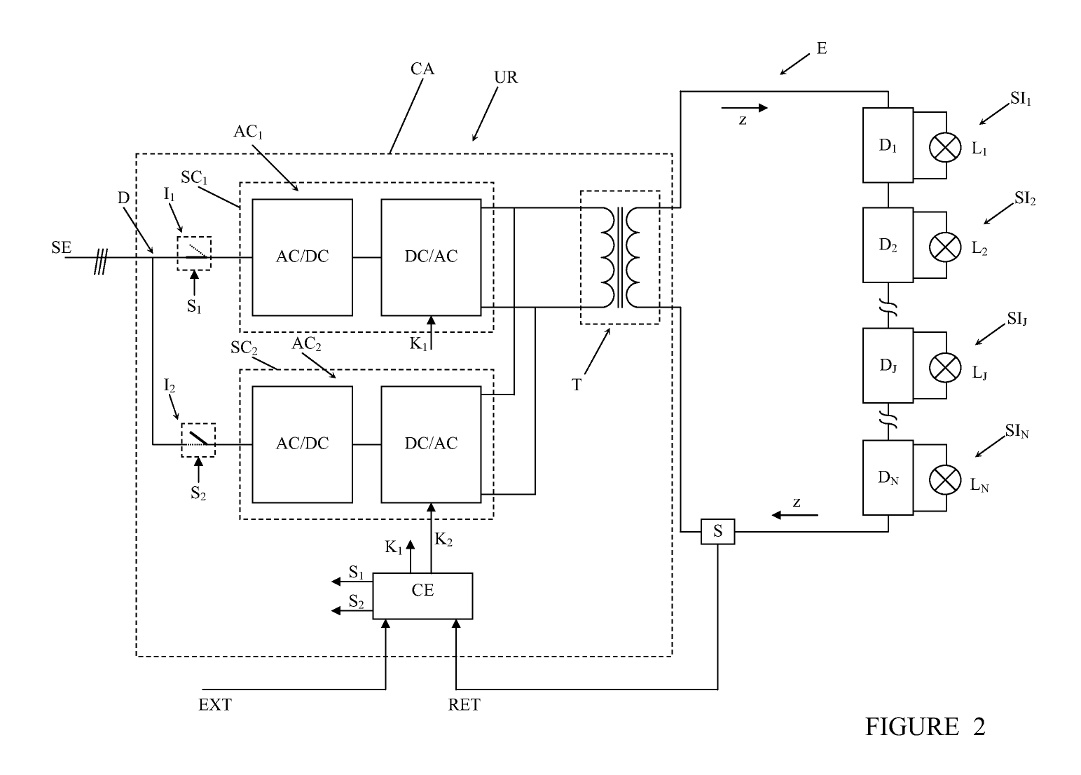

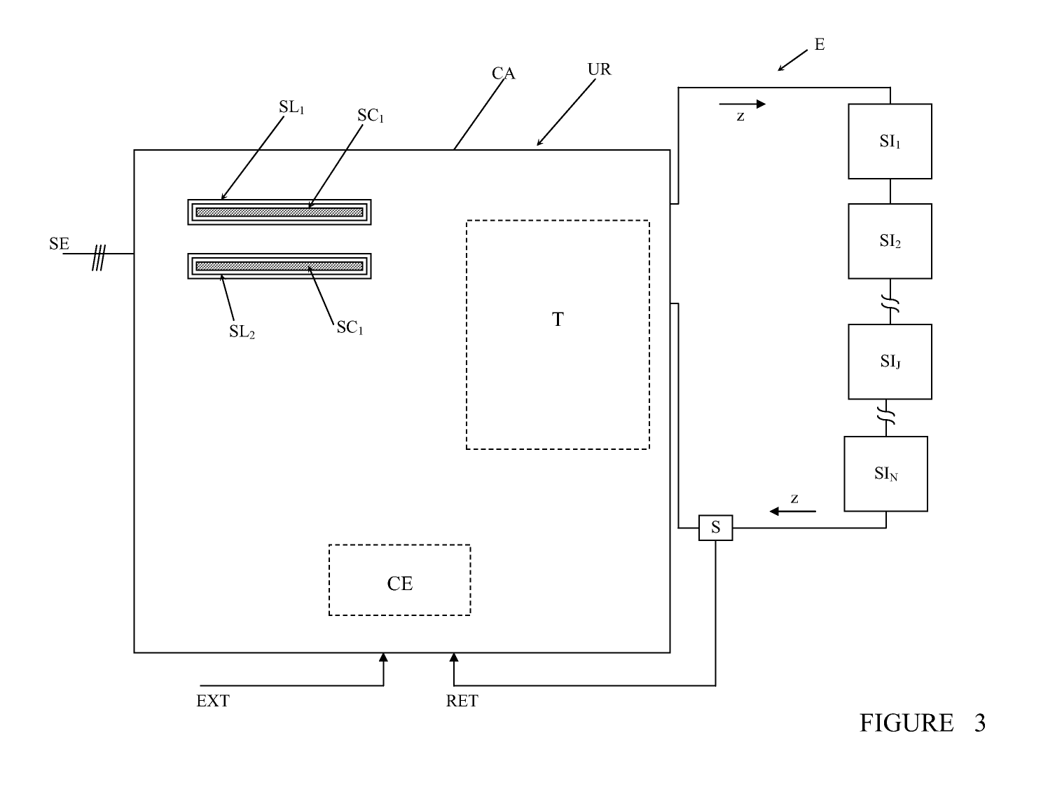

In the following description, regarding FIGS. 2, 3, some numerical references, already defined in FIG. 1 (prior art), will be maintained, since relating to elements, electric signals or electric units, common from the operation point of view.

The regulation unit UR, proposed by the invention (see in particular FIG. 2), is connected for example to a three-phase (or single-phase) power line SE to supply the electric circuit E; which has said plurality of light sources SI₁, SI₂, . . . , SI_{J}, . . . , SI_{N}, arranged in series. The regulation unit UR includes substantially: two conversion apparatuses AC₁, AC₂, arranged in parallel, each of which includes, in turn, an AC/DC rectifier, supplied by the power line SE, that converts the alternating three-phase or single-phase voltage in a direct voltage, and an inverter DC/AC, arranged in cascade with the corresponding rectifier AC/DC, aimed at converting the direct voltage again in an alternate voltage wave form, having pre-settable characteristics (frequency and/or amplitude and/or rms value; an electric transformer T, having primary winding connected to the output of the same DC/AC inverters of the two conversion apparatuses AC₁, AC₂ and the secondary winding connected to the electric circuit E. An electric control unit CE receives in input the external signal EXT, transmitted for example by the control tower, and the feedback control signal RET, supplied by the sensor S (such as a current transformer TA), representative of the current z circulating in the electric circuit E. The control unit is aimed at controlling the modulation of the voltage supplied by the DC/AC inverters by means of the corresponding signals K₁, K₂.

As specified also in the introductory note, the electric control unit CE has the task of controlling the modulation of the voltage generated by the DC/AC inverter of the conversion apparatus AC₁, or AC₂, for example in terms of variation of its rms value, depending on the result of the comparison between the external signal EXT, containing the information about the light level required in the runway and the feedback control signal RET. therefore, the electric control unit CE governs the control and regulation of the current z circulating in the electric circuit E, so as to obtain corresponding current values (not indicated) to supply the lamps L₁, L₂, L_{J}, . . . , L_{N}, the current being delivered by the auxiliary devices D₁, D₂ . . . , D_{J}, . . . , D_{N}.

According to FIG. 2, there can be switches I₁, I₂, situated for example, upstream of the conversion apparatuses AC₁, AC₂ and downstream of the branch point D of the latter, respectively. The activation/deactivation of the switches I₁, I₂ on the corresponding branch, in which they are inserted, is regulated for example by the electric control unit CE by the corresponding command signals S₁, S₂.

The regulation unit UR, see FIG. 3, is contained in a casing CA, whose front part features the openings of two slots SL₁, SL₂, for introduction/removal of corresponding printed boards SC₁, SC₂, on which said conversion apparatuses AC₁, AC₂ are mounted respectively. The printed boards SC₁, SC₂ have relative wiping contacts (not shown as known), aimed at engaging, on the introduction of the boards SC₁, SC₂, into corresponding inner seats of the slots SL₁, SL₂ (likewise not shown), so as to allow the conversion apparatuses AC₁, AC₂ to be connected electrically to the electric source SE, the transformer T and the electric control unit CE, thus obtaining the full operation of the regulation unit UR (FIG. 2).

FIG. 2 shows a possible operation configuration of the regulation unit UR, in which the switch I₁, is closed, allowing the supplying of the conversion apparatus AC₁, mounted on the board SC₁, and the switch I₂ is open; obviously, the light sources SI₁, SI₂, . . . , SI_{J}, . . . , SI_{N} will be supplied only by the conversion apparatus AC₁. A contrary situation would occur if the switch I₁ were open and the switch I₂ were closed. In particular, the presence of the switches I₁, I₂ allows introducing/removing each board SC₁, SC₂ into/from the suitable slot SL₁, SL₂, safely for the operator. The transfer of energy through one or the other conversion apparatus AC₁, AC₂, for supplying the light sources SI₁, SI₂, . . . , SI_{J}, SI_{N}, can be obtained by controlling the operation of the corresponding rectifier AC/DC and/or DC/AC inverter, as known.

Consequently, beginning from the configuration shown in FIG. 2, in case, for example, of a failure of the conversion apparatus AC₁, it is possible to divert the energy flow through the conversion apparatus AC₂, having the redundancy function, after having closed the switch I₂, thus ensuring the continuity of the supply to the light sources SI_{R}, SI₂, . . . SI_{J}, . . . , SI_{N}.

After having opened the switch I₁, the operator would be able to remove easily the faulty board SC₁, repairing it or substituting it with another one. The removal of the faulty board AC₁ and the introduction of a new one require few moments and can be performed later on, after the failure event, without particular hurry, since the regulation unit UR continues to work regularly, due to the activation of the redundancy apparatus AC₂.

Advantageously, the regulation unit UR is thus compact and extremely reliable, since its most critical elements, exactly from the reliability point of view, belong, as known, to the two conversion apparatuses AC₁, AC₂, one in service and the other in reserve or redundant, which however, as they are mounted on the respective boards SC₁, SC₂, can be removed and introduced quickly by the operator in case of possible malfunction, failure or maintenance of one of them. Moreover, with respect to the known solutions, a considerable reduction of the dimensions is followed by a consistent reduction of costs, due to the smaller number of functional elements (for example only one transformer T) of the regulation unit UR, proposed by the invention, with respect to two units of known type, one in service and one redundant, parallel to each other, substantially reliable to the same extent.

It is specified that if the electric source SE supplied a direct voltage, the rectifier devices AC/DC would be useless; therefore, each conversion apparatus AC₁, AC₂ would be formed substantially by the DC/AC inverter (the only mounted on the corresponding boards SC₁, SC₂).

It is also possible to provide more than two conversion apparatuses (not shown), one in service and the others redundant, or vice-versa, aimed at engaging with corresponding slots made in the regulation unit UR, according to a functional arrangement and an operation wholly comparable with what described above, in relation to the embodiment shown in the enclosed Figures.

Moreover, it is not excluded to use contemporarily the service apparatus AC₁ and the redundant one AC₂ (or ones, in case of more than two conversion apparatuses mounted on the corresponding slots), for the operation of the regulation unit UR.

The protective scope of the present invention includes also only one conversion apparatus AC₁ mounted on a suitable board SC₁.

In this case, the possible malfunction or damage to one element of the same apparatus AC₁ will require the immediate substitution of the board SC₁ by the operator, which will be rapid and simple removing safely the faulty board SC₁ and substituting it with a new one.

It is specified, in general, that the above mentioned conversion apparatuses, one redundant and two or more in service or vice-versa, can be connected to each other in series and/or in parallel.

1. A current regulation unit in a circuit composed of light sources, connected in series, the regulation unit being functionally interposed between an electric source (SE) and an electric circuit (E) including the said light sources (SI₁, SI₂, . . . , SI_{J}, SI_{N}), connected in series, the regulation unit including:
at least one conversion apparatus (AC₁, AC₂), supplied by said electric source (SE) for generating an alternating voltage, having presettable characteristics;
an electric transformer (T), electrically connected in cascade to the same conversion apparatus (AC₁, AC₂) and functionally connected to said electric circuit (E) of said light sources (SI₁, SI₂ . . . , SI_{J}, . . . , SI_{N}); and
an electric control unit (CE), connected to at least said conversion apparatus (AC₁, AC₂) for controlling modulation of the alternating voltage supplied by said conversion apparatus so as to obtain a current (z) in said electric circuit (E) of said light sources (SI₁, SI₂, . . . , SI_{J}, . . . , SI_{N}) having pre-settable electric characteristics, the current regulation unit being characterized in that said conversion apparatus (AC₁, AC₂) is mounted on a board (SC₁, SC₂), removable from a corresponding slot (SL₁, SL₂), made in the same regulation unit (UR).

2. A regulation unit, according to claim 1, including at least two of said conversion apparatuses (AC₁, AC₂), for generating an alternating voltage, having presettable characteristics, functionally interposed between said electric source (SE) and said electric transformer (T), each of said conversion apparatuses (AC₁, AC₂) being mounted on a corresponding board (SC₁, SC₂), removable from a corresponding slot (SL₁, SL₂), made in said regulation unit (UR).

3. A regulation unit, according to claim 2, wherein said conversion apparatuses (AC₁, AC₂), functionally interposed between said electric source (SE) and said electric transformer (T), are arranged in parallel one to another.

4. A regulation unit, according to claim 2, wherein said conversion apparatuses (AC₁, AC₂), functionally interposed between said electric source (SE) and said electric transformer (T), are connected in series.

5. A regulation unit, according to claim 2, wherein said conversion apparatuses (AC₁, AC₂), functionally interposed between said electric source (SE) and said electric transformer (T), are one in service and the other redundant or in reserve, and are also arranged in parallel.

6. A regulation unit, according to claim 1, wherein said board (SC₁, SC₂), of said corresponding conversion apparatus (AC₁, AC₂) is a printed board with wiping contacts, so that introduction or removal of the board from a corresponding slot (SL₁, SL₂) determines electric connection or disconnection, respectively, with and from corresponding parts on said regulation unit (UR).

7. A regulation unit, according to claim 1, wherein said electric source (SE) supplies a direct voltage and each of said conversion apparatuses (AC₁, AC₂) include an DC/AC inverter for transforming direct voltage, supplied by said electric source (SE), into alternating voltage, having pre-settable characteristics, supplied by said transformer (T).

8. A regulation unit, according to claim 1, wherein said electric source (SE) supplies an alternating voltage, and each of said conversion apparatuses (AC₁, AC₂) includes:
a rectifier AC/DC, powered by said electric source (SE) for converting alternating voltage supplied by the same electric source (SE) into direct voltage; and
a DC/AC inverter for transforming direct voltage, supplied by said rectifier AC/DC, into alternating voltage having pre-settable characteristics, supplied to said transformer (T).

9. A regulation unit, according to claim 2, wherein said board (SC₁, SC₂), of said corresponding conversion apparatus (AC₁, AC₂) is a printed board with wiping contacts, so that introduction or removal of the board from a corresponding slot (SL₁, SL₂) determines electric connection or disconnection, respectively, with and from corresponding parts on said regulation unit (UR).

10. A regulation unit, according to claim 2, wherein said electric source (SE) supplies a direct voltage and each of said conversion apparatuses (AC₁, AC₂) include an DC/AC inverter for transforming direct voltage, supplied by said electric source (SE), into alternating voltage, having pre-settable characteristics, supplied by said transformer (T).

11. A regulation unit, according to claim 2, wherein said electric source (SE) supplies an alternating voltage, and each of said conversion apparatuses (AC₁, AC₂) includes:
a rectifier AC/DC, powered by said electric source (SE) for converting alternating voltage supplied by the same electric source (SE) into direct voltage; and
a DC/AC inverter for transforming direct voltage, supplied by said rectifier AC/DC, into alternating voltage having pre-settable characteristics, supplied to said transformer (T).
